(19) United States
(12) Patent Application Publication
(10) Pub. No.: US 2016/0151929 A1
(43) Pub. Date: Jun. 2, 2016

(54) METHOD OF AND APPARATUS FOR DIVIDING PLATE MEMBER MADE OF BRITTLE MATERIAL

(71) Applicant: KAWASAKI JUKOGYO KABUSHIKI KAISHA, Kobe-she, Hyogo (JP)

(72) Inventors: Osami OGUSHI, Kobe-shi (JP); Takanori KIRITOSHI, Kobe-shi (JP); Mutsuhiro NAKAZAWA, Kobe-shi (JP); Keiji TSUJITA, Kobe-shi (JP)

(73) Assignee: KAWASAKI JUKOGYO KABUSHIKI KAISHA, Kobe-shi, Hyogo (JP)

(21) Appl. No.: 14/902,954

(22) PCT Filed: May 22, 2014
(86) PCT No.: PCT/JP2014/002684

§ 371 Date: Jan. 5, 2016

(30) Foreign Application Priority Data
Jul. 8, 2013 (JP) 2013-142943

(51) Int. Cl. B26F 3/00; B26F 3/06; C03B 33/09; B28D 5/00

(52) U.S. Cl. CPC B26F 3/002; B28D 5/0011; B26F 3/06; C03B 33/09

(57) ABSTRACT

A method of dividing a plate member made of a brittle material includes; first, forming a minute start point flaw 16 in a first main surface of a plate member on a division-planned line; then holding the first main surface of the plate member on a pair of lines; and thereafter, for example, bringing a dividing member, which heats up a second main surface of the plate member by contact heating, into contact with the second main surface of the plate member to generate a tensile thermal stress on the first main surface and applying bending force in a thickness direction of the plate member to the second main surface of the plate member, such that a tensile stress derived from the bending force and the tensile thermal stress are combined together. In this manner, the plate member is divided along the division-planned line.

### TECHNICAL FIELD

The present invention relates to a method of and an apparatus for dividing a plate member made of a brittle material.

### BACKGROUND ART

In recent years, plate members made of brittle materials, such as glass plates and semiconductor substrates (hereinafter, simply referred to as “plate members”), are often used in FPDs (Flat Panel Displays), building materials, automobile industry, etc. Some of the plate members are made very thin (e.g., with a thickness of 1 mm or less, and recently, even with a thickness of about 0.3 mm) for the purpose of, for example, weight reduction.

A plate member as above has been divided to have a desirable size, for example, for its intended use. A general method of dividing a plate member, such as a glass plate (hereinafter, a description is given taking a “glass plate” as one example of the plate member), includes: forming a scribe groove (a notch) in the glass plate by a mechanical cutter (a diamond cutter, cemented carbide wheel, or the like) along a division-planned line; and applying a mechanical stress (a bending stress) along the scribe groove to divide (cleave) the glass plate into pieces. In this case, dust such as swarf and fine cullet (hereinafter, “dividing dust”) is generated and contaminates the glass surface. Therefore, a cleaning device for cleaning up the dividing dust is necessary.

The strength of the edges of the pieces divided along the scribe groove is low, because fine chips or the like are caused on the edges by the mechanical cutter. Therefore, it is necessary to grind the edges. In addition, both a scribing device for forming the scribe groove and a dividing apparatus for cleaving the glass plate are necessary to realize high productivity. This results in high cost.

As one example of this kind of conventional art, there is a proposed method that includes: laying a heating line along a cutting line of a glass; and heating up the heating line to a predetermined temperature, and at the same time, exerting tensile force in a cutting direction over the entire glass to cause a crack to progress from one end surface of the glass, thereby forming a thermal stress crack along the cutting line and dividing the glass along the cutting line (see Non-Patent Literature 1, for example).

There is another proposed glass dividing method that includes: applying cooling air to a glass from the opposite side to a heating line laid on the glass while moving a nozzle that jets out the cooling air; and exerting tensile force in a cutting direction over the entire glass to cause a crack to progress from one end surface of the glass along a cutting line (see Patent Literature 1 and page 117 of Non-Patent Literature 1, for example).

As yet another example of conventional art, there is a method that includes: moving a spot heat source along a cutting line of a glass substrate, and at the same time, exerting tensile force in a cutting direction over the entire glass substrate to cause a thermal stress crack to progress along the cutting line, thereby dividing the glass substrate along the cutting line (see Patent Literature 2, for example).

As yet another example of conventional art, there is a method that includes: condensing laser light on the surface of a glass plate; scanning the light-condensing spot along an intended machining shape to perform scribing utilizing a thermal stress; and irradiating the scribed portion with laser light to cause heat distortion thereon, thereby cleaving the glass plate (see Patent Literature 3, for example).

### CITATION LIST

### Non-Patent Literature

NPL 1: “Study on Cleaving Process of a Brittle Thin Strip by Thermal Stress”, Nagasaki University, Graduate School of Science and Technology, Hiroshi Sawada, December 1998, pp. 103 to 107, 117, and 120.

### Patent Literature

PTL 1: Japanese Laid-Open Patent Application Publication No. H11-157863

PTL 2: Japanese Laid-Open Patent Application Publication No. 2011-84423

PTL 3: Japanese Laid-Open Patent Application Publication No. H05-32428

### SUMMARY OF INVENTION

### Technical Problem

However, in the method of Non-Patent Literature 1, in order to cause a crack to progress from a flaw formed in one end surface, it is necessary to heat up the heating line and exert tensile force in the cutting direction over the entire glass plate along the cutting line at the same time, which is possible for a small-sized glass. However, in the case of a large-sized glass with a size of 1000 mm or more, it is difficult to exert the tensile force along the cutting line. In addition, the progress of the crack is slow, resulting in low productivity.

In the methods described in pp. 117 of Non-Patent Literature 1 and Patent Literature 1, cooling air is applied while moving the nozzle that jets out the cooling air in order to cause the crack to progress. Even with these methods, the speed of dividing the glass is slow. Therefore, the productivity is low in the case of dividing a large-sized glass.

In the case of the method disclosed in Patent Literature 2, similar to the case of Non-Patent Literature 1, it is difficult to apply the technique of exerting tensile force in the cutting direction to such a plate member as a large-sized glass. In addition, since Patent Literature 2 utilizes the moving spot heat source, the apparatus used in Patent Literature 2 is more complex than the apparatus used in Non-Patent Literature 1.

The method disclosed in Patent Literature 3 is greatly affected by the values of the physical properties of the glass plate, and it is necessary to search for suitable conditions if the thickness and/or the type of the glass plate are changed. In addition, it takes time to form a thermal stress crack. Therefore, the processing speed is slow, and the productivity is low. In order to improve the productivity, a separate dividing apparatus is necessary, which results in an increase in the size of the equipment.

Moreover, in the case of a dividing apparatus using laser light as described in Patent Literature 2 or 3, the size of a laser light emitting device is large, and controlling its laser light emitting angle is difficult. Therefore, a large installation space and high cost are required.

In view of the above, an object of the present invention is to provide a compact dividing method that makes it possible to suppress the generation of dividing dust and improve productivity at the time of dividing a plate member made of a brittle material, and to provide a dividing apparatus capable of executing the dividing method.

### Solution to Problem

In order to achieve the above-described object, a brittle material plate member dividing method according to the present invention is a method of dividing a plate member made of a brittle material along a division-planned line. The method includes: forming a minute start point flaw in a first main surface of the plate member on the division-planned line; holding the first main surface of the plate member on a pair of lines between which the division-planned line is laid, the pair of lines being parallel to the division-planned line; and dividing the plate member along the division-planned line by bringing a dividing member that extends along the division-planned line and that heats up or cools down the plate member by contact heating or contact cooling into contact with the plate member to generate a tensile thermal stress on the first main surface of the plate member and by applying bending force in a thickness direction of the plate member to a second main surface of the plate member along the division-planned line, the second main surface facing in a direction opposite to a facing direction of the first main surface, such that a tensile stress derived from the bending force and the tensile thermal stress are combined together. In the description and the claims herein, the term “thermal stress” refers to a heat distortion stress that occurs inside the plate member made of a brittle material when the dividing member that has been either heated up or cooled down is brought into contact with the plate member. The term “minute” refers to the size of the flaw, which is up to several millimeters (e.g., 5 mm). The wording “apply bending force” means pushing upward the second main surface of the plate member on the division-planned line while holding the first main surface of the plate member on the pair of lines parallel to the division-planned line such that necessary bending deformation of the plate member occurs in the thickness direction of the plate member.

According to this configuration, by bringing the dividing member, which heats up or cools down the plate member made of a brittle material by contact heating or contact cooling, into contact with the plate member along the division-planned line, a tensile thermal stress can be generated on the first main surface of the plate member, in which the start point flaw is formed. For example, in the case of bringing the dividing member that heats up the second main surface of the plate member by contact heating into contact with the second main surface of the plate member, a compression thermal stress derived from thermal expansion is generated on the second main surface of the plate member along the division-planned line owing to a temperature difference between the second main surface and the first main surface, and a tensile thermal stress derived from reaction force of the thermal expansion is generated on the first main surface. On the other hand, in the case of bringing the dividing member that cools down the first main surface of the plate member by contact cooling into contact with the first main surface of the plate member, a tensile thermal stress derived from thermal contraction is generated on the first main surface of the plate member along the division-planned line owing to a temperature difference between the first main surface and the second main surface, and a compression thermal stress derived from reaction force of the thermal contraction is generated on the second main surface. Further, when bending force in the thickness direction of the plate member is applied to the second main surface of the plate member along the division-planned line, a tensile stress derived from the bending force and the above tensile thermal stress are combined together on the first main surface of the plate member. As a result, a crack progresses from the start point flaw along the division-planned line. It should be noted that the bending force may be applied before or after the tensile thermal stress is generated, or may be applied at the same time as the tensile thermal stress is generated. Consequently, the plate member can be divided along the division-planned line. According to this method, the plate member is divided apart instantly, and thereby the productivity can be improved. Moreover, it is not necessary to form a groove or divide the plate member by mechanical machining, and merely forming the minute start point flaw in the first main surface of the plate member will suffice. This makes it possible to suppress the generation of cullet at the time of dividing the plate member. Furthermore, it is not necessary to clean the plate member after dividing it. Therefore, the work of dividing the plate member can be performed with a very simple apparatus.

The dividing member may be disposed at the second main surface side of the plate member and heats up the second main surface of the plate member by contact heating. The dividing member may be brought into contact with the second main surface of the plate member to generate the tensile thermal stress on the first main surface of the plate member. The dividing member may be pressed onto the plate member to apply the bending force in the thickness direction of the plate member to the second main surface of the plate member.

According to this configuration, by bringing the dividing member, which heats up the second main surface of the plate member by contact heating, into contact with the second main surface of the plate member along the division-planned line and pressing the dividing member onto the plate member, a compression thermal stress derived from thermal expansion and a compression stress derived from the bending force act on the second main surface of the plate member along the division-planned line, and also, a tensile thermal stress derived from reaction force of the thermal expansion and a tensile stress derived from the bending force act on the first main surface. Owing to these stresses generated along the division-planned line, the plate member can be divided. In addition, the bending force can be applied to the second main surface of the plate member by utilizing the dividing member, which heats up the second main surface of the plate member by contact heating.

Dividing the plate member may include: bringing the dividing member into contact with the second main surface of the plate member; and bringing a secondary dividing member that is disposed at the first main surface side of the plate member in a manner extending along the division-planned line and that cools down the first main surface of the plate member by contact cooling into contact with the first main surface of the plate member.

According to this configuration, in addition to the tensile thermal stress derived from the reaction force of the thermal expansion resulting from the heating of the second main surface and its vicinity by the dividing member and the tensile stress derived from the bending force, a tensile thermal stress derived from thermal contraction resulting from the cooling of the first main surface and its vicinity by the secondary dividing member acts on the first main surface of the plate member. In this manner, a greater stress can be generated along the division-planned line to divide the plate member.

The dividing member may be disposed at the first main surface side of the plate member and cool down the first main surface of the plate member by contact cooling. Dividing the plate member may include: bringing the dividing member into contact with the first main surface of the plate member; and pressing a pressing member that is disposed facing the dividing member and that extends along the division-planned line onto the plate member against the dividing member to apply the bending force in the thickness direction of the plate member to the second main surface of the plate member.

According to this configuration, by bringing the dividing member, which cools down the first main surface of the plate member by contact cooling, into contact with the first main surface of the plate member along the division-planned line, a tensile thermal stress derived from thermal contraction is generated on the first main surface. In addition, by pressing the pressing member onto the plate member along the division-planned line, a tensile stress derived from the bending force is generated on the first main surface. Therefore, owing to these stresses, the plate member can be divided along the division-planned line.

Dividing the plate member may include pulling the plate member in a direction perpendicular to the division-planned line.

According to this configuration, a tensile stress derived from tensile force can be combined with the tensile thermal stress and the tensile stress derived from the bending force, which act on the first main surface of the plate member, and thereby the plate member can be divided along the division-planned line.

For example, the plate member may be pulled in a direction perpendicular to the division-planned line at the same time as bringing the dividing member, which heats up or cools down the plate member by contact heating or contact cooling, into contact with the plate member. According to this configuration, the tensile thermal stress and the tensile stress derived from the tensile force can be combined together. This makes it possible to divide the plate member along the division-planned line within a shorter period of time.

The start point flaw may be formed in an end portion of the plate member.

According to this configuration, the plate member can be divided in a manner to cleave the plate member from the end portion where the start point flaw is formed, and thereby the plate member can be smoothly divided along the division-planned line.

A brittle material plate member dividing apparatus according to one aspect of the present invention is an apparatus for dividing a plate member made of a brittle material along a division-planned line, the plate member including a first main surface, in which a minute start point flaw is formed on the division-planned line. The apparatus includes: a pair of holding members that holds the first main surface of the plate member on a pair of lines between which the division-planned line is laid, the pair of lines being parallel to the division-planned line; a dividing member that is disposed at a second main surface side of the plate member in a manner extending along the division-planned line and that heats up a second main surface of the plate member by contact heating, the second main surface facing in a direction opposite to a facing direction of the first main surface; and a driver that drives the dividing member to bring the dividing member into contact with the second main surface of the plate member to generate a tensile thermal stress on the first main surface of the plate member and press the dividing member onto the plate member to apply bending force in a thickness direction of the plate member to the second main surface of the plate member along the division-planned line, such that a tensile stress derived from the bending force and the tensile thermal stress are combined together and the plate member is divided along the division-planned line.

According to this configuration, by bringing the dividing member, which heats up the second main surface of the plate member made of a brittle material by contact heating, into contact with the second main surface of the plate member along the division-planned line, a compression thermal stress derived from thermal expansion is generated on the second main surface of the plate member along the division-planned line owing to a temperature difference between the second main surface and the first main surface, and a tensile thermal stress derived from reaction force of the thermal expansion is generated on the first main surface. Further, when bending force in the thickness direction of the plate member is applied to the second main surface of the plate member along the division-planned line, a tensile stress derived from the bending force and the above tensile thermal stress are combined together on the first main surface of the plate member. As a result, a crack progresses from the start point flaw along the division-planned line. Consequently, the plate member can be divided along the division-planned line. According to this apparatus, the plate member is divided apart instantly, and thereby the productivity can be improved. Moreover, it is not necessary to form a groove or divide the plate member by mechanical machining, and merely forming the minute start point flaw in the first main surface of the plate member will suffice. This makes it possible to suppress the generation of cullet at the time of dividing the plate member. Furthermore, it is not necessary to clean the plate member after dividing it. Therefore, the work of dividing the plate member can be performed with a very simple apparatus.

In addition, according to the above configuration, by bringing the dividing member, which heats up the second main surface of the plate member by contact heating, into contact with the second main surface of the plate member along the division-planned line of the plate member and pressing the dividing member onto the plate member, a compression thermal stress derived from thermal expansion and a compression stress derived from the bending force act on the second main surface of the plate member along the division-planned line, and also, a tensile thermal stress derived from reaction force of the thermal expansion and a tensile stress derived from the bending force act on the first main surface. Owing to these stresses generated along the division-planned line, the plate member can be divided. In addition, the bending force can be applied to the second main surface of the plate member by utilizing the dividing member, which heats up the plate member.

The apparatus may further include a secondary dividing member that is disposed at the first main surface side of the plate member in a manner extending along the division-planned line and that is brought into contact with the first main surface of the plate member to cool down the first main surface of the plate member by contact cooling.

According to this configuration, in addition to the tensile thermal stress derived from the reaction force of the thermal expansion resulting from the heating of the second main surface and its vicinity by the dividing member and the tensile stress derived from the bending force, a tensile thermal stress derived from thermal contraction resulting from the cooling of the first main surface and its vicinity by the secondary dividing member acts on the first main surface of the plate member. In this manner, a greater stress can be generated along the division-planned line to divide the plate member.

A brittle material plate member dividing apparatus according to another aspect of the present invention is an apparatus for dividing a plate member made of a brittle material along a division-planned line, the plate member including a first main surface, in which a minute start point flaw is formed on the division-planned line. The apparatus includes: a pair of holding members that holds the first main surface of the plate member on a pair of lines between which the division-planned line is laid, the pair of lines being parallel to the division-planned line; a dividing member that is disposed at the first main surface side of the plate member in a manner extending along the division-planned line and that cools down the first main surface of the plate member by contact cooling; a first driver that drives the dividing member to bring the dividing member into contact with the first main surface of the plate member to generate a tensile thermal stress on the first main surface of the plate member; a pressing member disposed facing the dividing member and extending along the division-planned line; and a second driver that drives the pressing member to press the pressing member onto the plate member against the dividing member to apply bending force in a thickness direction of the plate member to a second main surface of the plate member along the division-planned line, the second main surface facing in a direction opposite to a facing direction of the first main surface, such that a tensile stress derived from the bending force and the tensile thermal stress are combined together and the plate member is divided along the division-planned line.

According to this configuration, by bringing the dividing member, which cools down the first main surface of the plate member made of a brittle material by contact cooling, into contact with the first main surface of the plate member along the division-planned line, a tensile thermal stress derived from thermal contraction is generated on the first main surface of the plate member along the division-planned line and a compression thermal stress derived from reaction force of the thermal contraction is generated on the second main surface owing to a temperature difference between the first main surface and the second main surface. Further, when bending force in the thickness direction of the plate member is applied to the second main surface of the plate member along the division-planned line, a tensile stress derived from the bending force and the above tensile thermal stress are combined together on the first main surface of the plate member. As a result, a crack progresses from the start point flaw along the division-planned line. Consequently, the plate member can be divided along the division-planned line. According to this apparatus, the plate member is divided apart instantly, and thereby the productivity can be improved. Moreover, it is not necessary to form a groove or divide the plate member by mechanical machining, and merely forming the minute start point flaw in the first main surface of the plate member will suffice. This makes it possible to suppress the generation of cullet at the time of dividing the plate member. Furthermore, it is not necessary to clean the plate member after dividing it. Therefore, the work of dividing the plate member can be performed with a very simple apparatus.

In addition, according to the above configuration, by bringing the dividing member, which cools down the first main surface of the plate member by contact cooling, into contact with the first main surface of the plate member along the division-planned line, a tensile thermal stress derived from thermal contraction is generated on the first main surface. Also, by pressing the pressing member onto the plate member along the division-planned line to apply bending force to the plate member, a tensile stress derived from the bending force is generated on the first main surface. Therefore, owing to these stresses, the plate member can be divided along the division-planned line.

The apparatus may further include a tensile machine that pulls the plate member in a direction perpendicular to the division-planned line.

According to this configuration, a tensile stress derived from tensile force can be combined with the tensile thermal stress and the tensile stress derived from the bending force, which act on the first main surface of the plate member, and thereby the plate member can be divided along the division-planned line.

For example, the tensile machine may be configured to pull the plate member in a direction perpendicular to the division-planned line at the same time as bringing the dividing member that heats up the plate member by contact heating or the dividing member that cools down the plate member by contact cooling into contact with the plate member. According to this configuration, the tensile thermal stress and the tensile stress derived from the tensile force can be combined together. This makes it possible to divide the plate member along the division-planned line within a shorter period of time. In this case, if the dividing apparatus is a vertically installed apparatus and these operations are performed in a state where the plate member is upright, the weight of the plate member can be utilized as the tensile force. This makes it possible to simplify the dividing apparatus.

The apparatus may further include a flaw forming device that forms the start point flaw in the first main surface of the plate member on the division-planned line.

According to this configuration, the steps of the dividing method of the present invention from the flaw forming step to the plate member dividing step can be realized by a single dividing apparatus.

A portion of the dividing member that heats up the second main surface of the plate member by contact heating, the portion coming into contact with the plate member, may be formed to have a shape that has a contact angle less than an angle of bend of the plate member when the plate member is divided along the division-planned line. Alternatively, a portion of the pressing member, the portion coming into contact with the plate member, may be formed to have a shape that has a contact angle less than an angle of bend of the plate member when the plate member is divided along the division-planned line.

According to the above configurations, brittle fracture of the plate member can be caused while keeping a state where the dividing member or the pressing member is in contact with the plate member along the division-planned line. This makes it possible to divide the plate member along the division-planned line in a stable manner.

### Advantageous Effects of Invention

According to the present invention, the generation of dividing dust can be suppressed at the time of dividing the plate member, and the dividing apparatus can be configured as a compact dividing apparatus with reduced apparatus components.

### BRIEF DESCRIPTION OF DRAWINGS

FIG. 1 is a perspective view showing a plate member dividing apparatus according to Embodiment 1 of the present invention.

FIG. 2 is a side view of the dividing apparatus shown in FIG. 1.

FIG. 3A shows a cross section of a dividing member shown in FIG. 1.

FIG. 3B shows another example of the cross section of the dividing member.

FIG. 3C shows yet another example of the cross section of the dividing member.

FIG. 3D shows yet another example of the cross section of the dividing member.

FIG. 4 is an enlarged side view illustrating functions that are exercised at the time of dividing a glass plate by the dividing apparatus shown in FIG. 2.

FIG. 5A is a perspective view of a plate member, showing one example of the position of a start point flaw.

FIG. 5B is a perspective view of the plate member, showing another example of the position of the start point flaw.

FIG. 6 is a side view showing a plate member dividing apparatus according to Embodiment 2 of the present invention.

FIG. 7 is a side view showing a plate member dividing apparatus according to Embodiment 3 of the present invention.

FIG. 8 is an enlarged side view illustrating functions that are exercised at the time of dividing a glass plate by the dividing apparatus shown in FIG. 7.

FIG. 9 is a side view showing a plate member dividing apparatus according to Embodiment 4 of the present invention.

FIG. 10A is a perspective view of the dividing member shown in FIG. 1.

FIG. 10B is a perspective view showing another example of the dividing member.

FIG. 10C is a perspective view showing yet another example of the dividing member.

FIG. 10D is a perspective view showing yet another example of the dividing member.

### DESCRIPTION OF EMBODIMENTS

Hereinafter, embodiments of the present invention are described with reference to the drawings. In the embodiments described below, a glass plate 1 is taken as an example of a plate member made of a brittle material, and major components and functions of a plate member dividing apparatus are described while the description of specific mechanisms is omitted.

### Embodiment 1

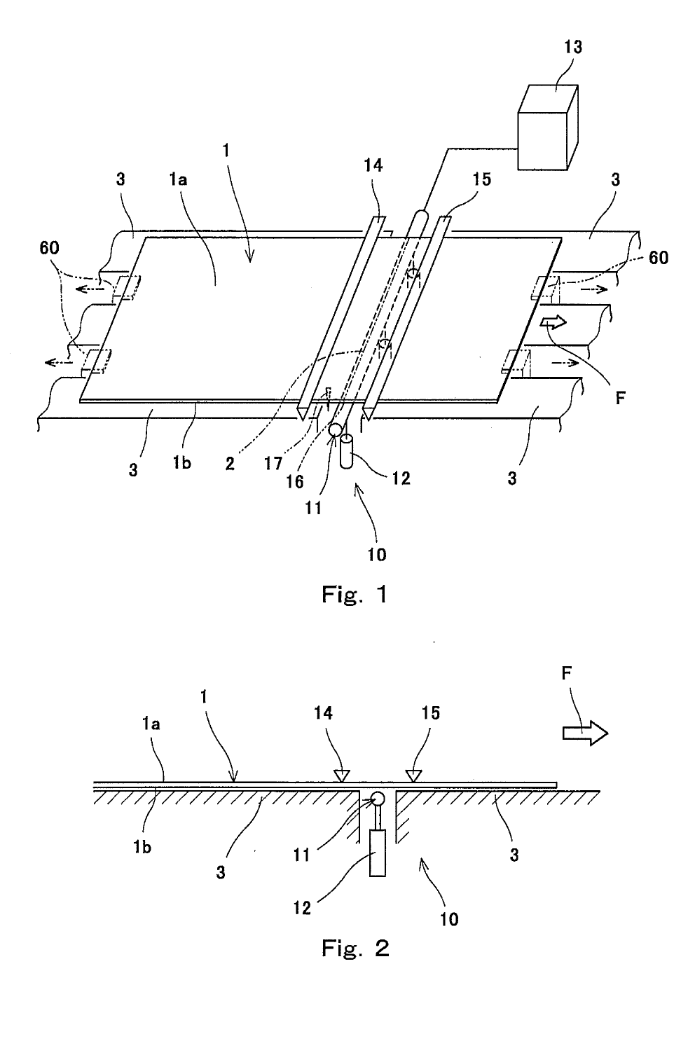

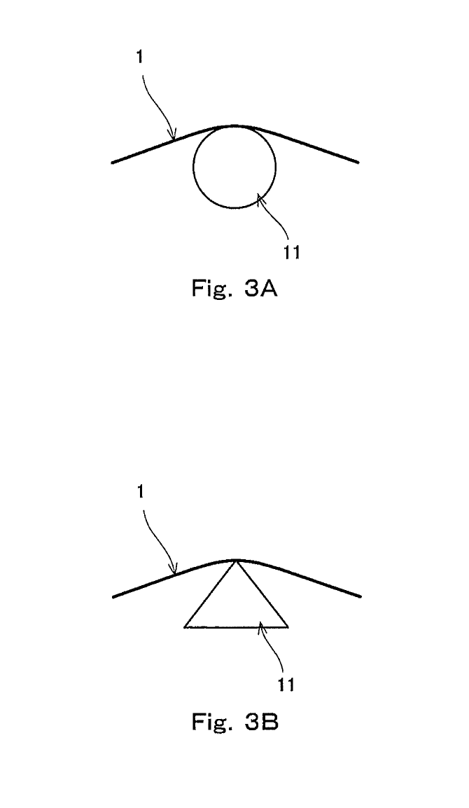

A plate member dividing apparatus 10 according to Embodiment 1 shown in FIGS. 1 and 2 indicates one example in which a dividing member 11, which heats up a glass plate 1 by contact heating, is used to divide the glass plate 1 along a division-planned line 2. The division-planned line 2 is an imaginary line, for example.

The glass plate 1 includes: a first main surface 1a, in which a minute start point flaw 16 is formed on the division-planned line 2; and a second main surface 1b facing in a direction opposite to the facing direction of the first main surface 1a. In the present embodiment, the glass plate 1 is divided in a state where the glass plate 1 is parallel to a horizontal plane. Accordingly, the first main surface 1a is an upper surface, and the second main surface 1b is a lower surface. However, as an alternative, the glass plate 1 may be parallel to, for example, the vertical direction such that both the first main surface 1a and the second main surface 1b face in the horizontal direction.

The glass plate 1 is conveyed in a conveying direction F from the left side to the right side in FIG. 1. A conveying apparatus 3 shown in FIG. 1 indicates one example in which the glass plate 1 is conveyed in such a manner that the glass plate 1 is floated by gas. Alternatively, the conveying apparatus 3 may convey the glass plate 1 by use of rollers, for example

The glass plate 1 conveyed by the conveying apparatus 3 is stopped at a predetermined position, heated up by the dividing member 11 by contact heating, and then divided. The dividing member 11 is disposed below the glass plate 1, i.e., disposed at the second main surface 1b side of the glass plate 1, in a manner crossing the conveying direction F. In the present embodiment, the dividing member 11 extends along the division-planned line 2, which is perpendicular to the conveying direction F of the glass plate 1.

The dividing member 11 is configured to be driven by a driver 12 to advance toward or retreat from the glass plate 1. The driver 12 drives the dividing member 11 to move upward or downward. As a result of the dividing member 11 being driven by the driver 12 to move upward, the dividing member 11 is pressed onto the glass plate 1. The driver 12 may be any device, so long as the device causes the dividing member 11 to advance or retreat precisely. As one example, a linear actuator can be used as the driver 12.

The dividing member 11 is connected to a heater 13. The heater 13 heats up the surface of the dividing member 11 and its vicinity to a predetermined heating temperature. The dividing member 11, by coming into contact with the second main surface 1b of the glass plate 1, heats up a portion of the second main surface 1b, the portion being contacted by the dividing member 11, to a temperature that is substantially the same as the temperature of the dividing member 11. As one example, a sheathed heater can be used as the dividing member 11 heated by the heater 13. The predetermined heating temperature of the dividing member 11 is about 100° C. to 400° C., for example. The heating temperature is set in accordance with the plate member.

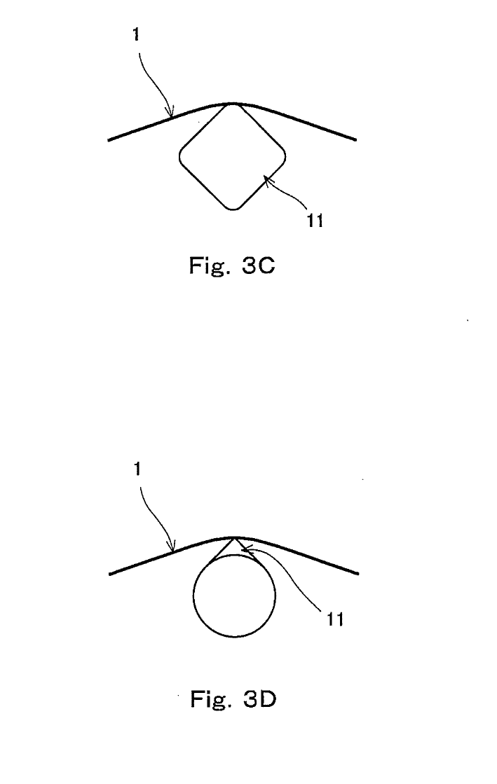

The cross-sectional shape of the dividing member 11 is not limited to round as shown in FIG. 3A, but may be, for example, triangular as shown in FIG. 3B or rectangular as shown in FIG. 3C, or alternatively, the dividing member 11 may have such a cross-sectional shape that a portion of the dividing member 11, the portion coming into contact with the glass plate 1, is pointy as shown in FIG. 3D. The cross-sectional shape of the dividing member 11 is set such that the portion of the dividing member 11, the portion coming into contact with the glass plate (plate member) 1, has a contact angle less than an angle of bend of the glass plate 1 when the glass plate 1 is divided.

Meanwhile, as shown in FIGS. 1 and 2, a pair of holding members 14 and 15 is provided above the glass plate 1, i.e., provided at the first main surface 1a side of the glass plate 1. The pair of holding members 14 and 15 holds the first main surface 1a of the glass plate 1 on a pair of lines parallel to the division-planned line 2. In the present embodiment, the holding members 14 and 15 are arranged such that they hold the glass plate 1 at respective positions between which the division-planned line 2 is laid. The holding members 14 and 15 are lifted and lowered by drivers that are not shown. As one example, rod-like members made of resin or rubber are used as the holding members 14 and 15.

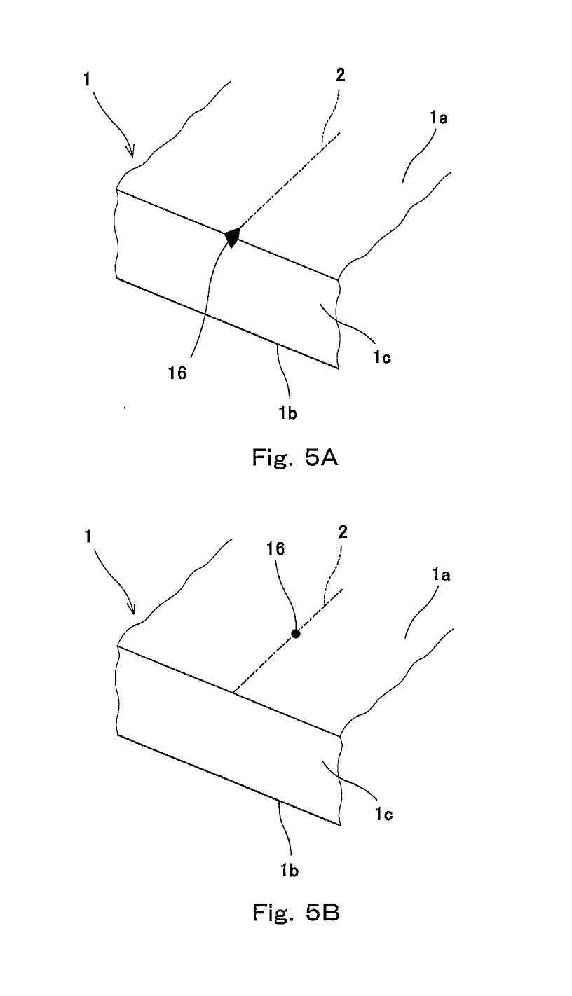

As shown in FIG. 1, in the present embodiment, the dividing apparatus 10 includes a flaw forming device 17, which forms a minute start point flaw (scribed mark) 16 in the first main surface 1a of the glass plate 1 on the division-planned line 2. It is desirable that the start point flaw 16 be formed in an end portion of the glass plate 1. The reason for this is that, by forming such a start point flaw 16, the glass plate 1 can be divided in a manner to cleave the glass plate 1 from the end portion where the start point flaw 16 is formed, and thereby the glass plate 1 can be smoothly divided along the division-planned line 2. The “end portion of the glass plate 1” herein refers to each of both non-middle portions of the glass plate 1 when the glass plate 1 is equally trisected in the extending direction of the division-planned line 2. For example, as shown in FIG. 5A, the start point flaw 16 may be formed at the corner between the first main surface 1a and an end surface 1c of the glass plate 1. Alternatively, as shown in FIG. 5B, the start point flaw 16 may be formed at a position that is located slightly inward from the end surface 1c of the glass plate 1. It should be noted that the timing of forming the start point flaw 16 by the flaw forming device 17 may be either before or after the holding members 14 and 15 hold the first main surface 1a of the glass plate 1.

For example, the flaw forming device 17 may form an incision line of about 1 to 2 mm or a dotted flaw in an end portion of the glass plate 1 as the minute start point flaw 16. In the present embodiment, a cutter that forms the start point flaw 16 from the lateral direction before the division-planned line 2 reaches the position of the dividing member 11 is adopted as the flaw forming device 17.

After the glass plate 1 has been stopped by the conveying apparatus 3 at the predetermined position and the start point flaw 16 has been formed in the first main surface 1a, the glass plate 1 is held down onto the conveying apparatus 3 by the holding members 14 and 15. In this state, the dividing member 11 heated to the predetermined heating temperature is brought into contact with the second main surface 1b of the glass plate 1 along the division-planned line 2. As a result, a great temperature gradient occurs between the second main surface 1b and the first main surface 1a of the glass plate 1. Consequently, a compression thermal stress derived from thermal expansion is generated on the second main surface 1b, and a tensile thermal stress derived from reaction force of the thermal expansion is generated on the first main surface 1a.

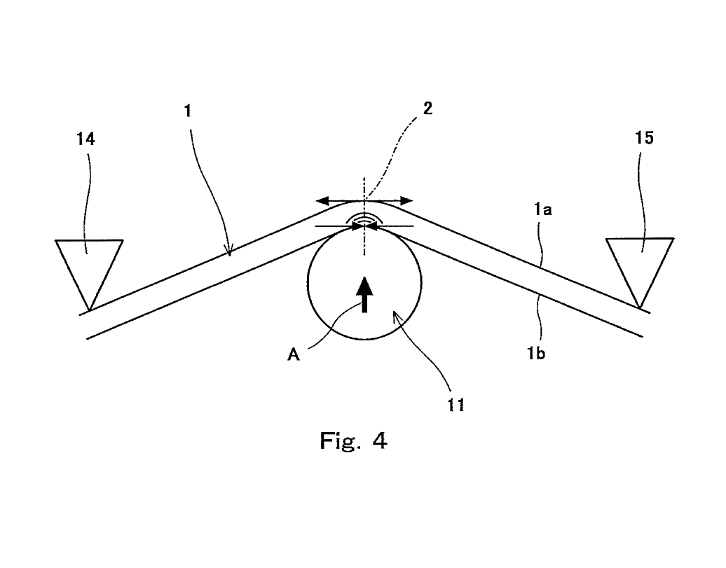

Thereafter, while the temperature difference between the first main surface 1a and the second main surface 1b of the glass plate 1 is kept great, in other words, before the temperature of the first main surface 1a is brought close to the temperature of the second main surface 1b as a result of thermal conduction, the dividing member 11 is pressed onto the glass plate 1. In this manner, as shown in FIG. 4, bending force A in the thickness direction of the glass plate 1 is applied to the second main surface 1b of the glass plate 1 along the division-planned line 2. Then, owing to a stress derived from the bending force and the thermal stress derived from the dividing member 11, the glass plate 1 made of a brittle material is divided along the division-planned line 2.

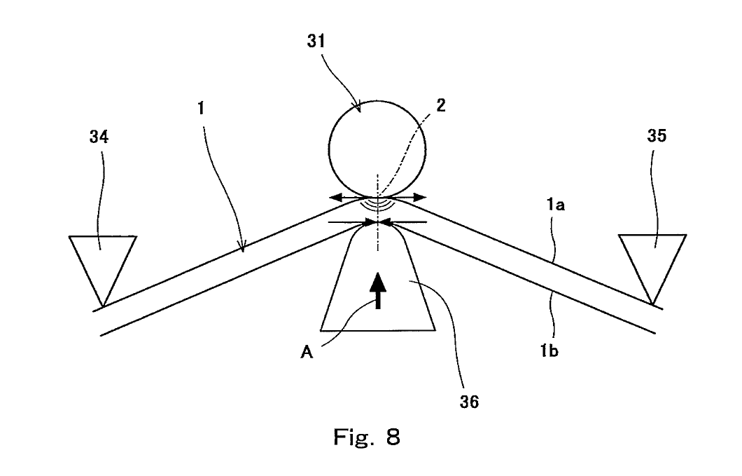

Further, as shown in FIG. 1, a tensile machine 60 (indicated by two-dot chain lines) for pulling the glass plate (plate member) 1 in a direction perpendicular to the division-planned line 2 may be provided. The tensile machine 60 may be any machine, so long as it is capable of pulling the glass plate (plate member) 1 in opposite directions with respect to the division-planned line 2. In this example, the tensile machine 60 grips and pulls end portions of the glass plate 1. Before or at the same time as the dividing member 11 is pressed onto the glass plate 1, the tensile machine 60 may apply tensile force to the glass plate 1 to divide the glass plate 1 along the division-planned line 2. In this case, depending on the type of the glass plate (plate member) 1, merely applying the tensile force by means of the tensile machine 60 at the same time as heating up the glass plate 1 along the division-planned line 2 by means of the dividing member 11 in a manner described below will suffice. It should be noted that, as described in Embodiment 3, in the case of bringing a dividing member 31 (see FIG. 7), which cools down the glass plate 1, into contact with the first main surface 1a of the glass plate 1, the tensile force may be applied to the glass plate 1 by means of the tensile machine 60 before bringing the dividing member 31 into contact with the first main surface 1a. By applying the tensile force in this manner, the glass plate (plate member) 1 can be divided by utilizing a thermal stress that is derived from the dividing member 31 and that is generated along the division-planned line 2 of the glass plate 1 and a tensile stress that is derived from the tensile force.

Assume that the dividing apparatus 10 is a vertically installed apparatus and the tensile machine 60 applies the tensile force in a state where the glass plate (plate member) 1 is upright such that the division-planned line 2 is parallel to the horizontal direction. In this case, the weight of the glass plate (plate member) 1 can be utilized as the tensile force. In this case, however, the holding members 14 and 15 and members facing them (corresponding to the above-described conveying apparatus 3; not shown) are rollers provided with antifriction bearings and lightly hold the glass plate (plate member) 1. Alternatively, the holding members 14 and 15 may keep a slight gap to the glass plate 1 and merely restrict deformation of the glass plate 1 without holding the glass plate 1.

FIG. 4 is an enlarged side view illustrating functions that are exercised at the time of dividing the glass plate 1 by the dividing apparatus 10. In FIG. 4, changes that occur when the dividing member 11 is pressed onto the glass plate 1 are shown in an exaggerated manner.

When the dividing member 11 is brought into contact with the second main surface 1b of the glass plate 1 along the division-planned line 2 in the above-described manner, the glass plate 1 is heated up from the second main surface 1b side along the division-planned line 2 (heat is indicated by arcs). Owing to a temperature difference between the second main surface 1b and the first main surface 1a, a compression thermal stress derived from thermal expansion is generated on the second main surface 1b, and a tensile thermal stress derived from reaction force of the thermal expansion is generated on the first main surface 1a. Thereafter, when the dividing member 11 is pressed onto the glass plate 1, bending force A in the thickness direction of the glass plate 1 is applied to the second main surface 1b of the glass plate 1 along the division-planned line 2. The moment that acts on the glass plate 1 is greatest at a position where the dividing member 11 contacts the glass plate 1. As a result, a compression stress acts on the second main surface 1b of the glass plate 1, and a tensile stress acts on the first main surface 1a (indicated by arrows).

Accordingly, along the division-planned line 2 of the glass plate 1, the compression stress derived from the bending force A is combined with the compression thermal stress derived from the thermal expansion, and these stresses act on the second main surface 1b. Further, the tensile stress derived from the bending force A is combined with the tensile thermal stress derived from the reaction force of the thermal expansion of the second main surface 1b, and these stresses act on the first main surface 1a. As a result, a crack progresses along the division-planned line 2 from the start point flaw 16 formed in the first main surface 1a. Consequently, the glass plate 1 made of a brittle material is divided along the division-planned line 2 owing to brittle fracture. That is, the thermal stress that occurs from the temperature difference between the front and the back of the glass plate 1, the temperature difference being caused by the heating by the dividing member 11, and the stress derived from the bending force A applied to the glass plate 1 by the dividing member 11 are combined together to become a fracture stress, and as a result, the glass plate 1 is divided. In addition, owing to these stresses, the glass plate 1 can be divided apart instantly (e.g., in about 1 to 3 seconds).

As described above, the axis of the dividing member 11 is brought into contact with the glass plate 1 along the division-planned line 2, and at the same time, a bending moment is caused to act on the glass plate 1 along the division-planned line 2. This makes it possible to instantly divide the glass plate 1 apart along the axis of the dividing member 11 (i.e., along the division-planned line 2).

Therefore, according to the dividing apparatus 10, the generation of dividing dust can be suppressed at the time of dividing the glass plate (plate member) 1, and the dividing apparatus 10 can be configured as a compact dividing apparatus with reduced apparatus components.

### Embodiment 2

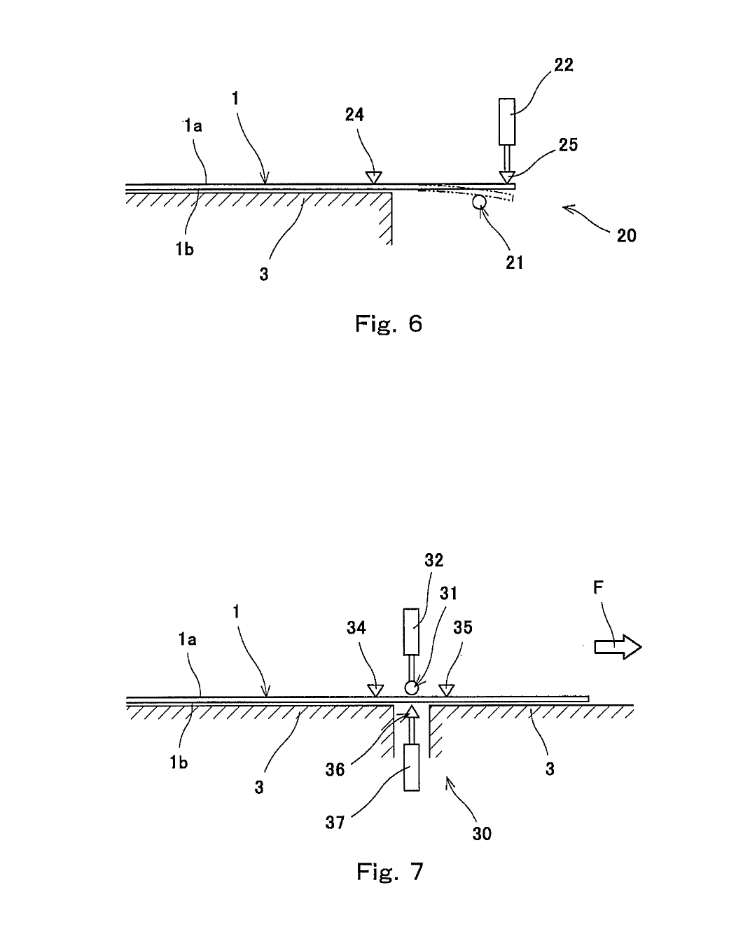

FIG. 6 is a perspective view showing a plate member dividing apparatus according to Embodiment 2. In a dividing apparatus 20 according to Embodiment 2, a dividing member 21, which heats up the glass plate 1 by contact heating, is disposed at a fixed position below the glass plate 1, i.e., at the second main surface 1b side of the glass plate 1. An end portion of the glass plate 1 is pushed down to the dividing member 21 from the upper side, i.e., from the first main surface 1a side, and thereby the glass plate 1 is divided along the division-planned line 2.

In the present embodiment, the dividing member 21 is disposed at a position that is away from the conveying apparatus 3 by a predetermined distance in the conveying direction and that is below the second main surface 1b of the conveyed glass plate 1. The position is away from the second main surface 1b by a predetermined distance (e.g., several mm). The position where the dividing member 21 is disposed is set in accordance with, for example, the thickness and bending strength of the glass plate (plate member) 1, which is divided in a manner described below. The dividing member 21 is configured in the same manner as the dividing member 11 of Embodiment 1 except that the dividing member 21 is of a fixed type.

A pair of holding members 24 and 25 is provided above the glass plate 1, i.e., provided at the first main surface 1a side of the glass plate 1. The pair of holding members 24 and 25 holds the first main surface 1a of the glass plate 1 on a pair of lines between which the division-planned line 2 is laid, the pair of lines being parallel to the division-planned line 2. The holding members 24 and 25 are lifted and lowered by drivers (only a driver 22 for lifting and lowering the holding member 25 is shown). In the present embodiment, the driver corresponding to the holding member 24 provided rearward in the conveying direction of the glass plate 1 lifts and lowers the holding member 24 by a small stroke to hold the glass plate 1 at a regular position. The driver 22 corresponding to the holding member 25 provided forward in the conveying direction of the glass plate 1 operates by a great stroke so that the front end portion of the glass plate 1 can be pushed downward to the dividing member 21.

According to the dividing apparatus 20 of the present embodiment, an end portion of the glass plate 1 is protruded from the conveying apparatus 3 by a predetermined amount, and the glass plate 1 is stopped at such a position that the division-planned line 2 coincides with the dividing member 21 (i.e., a position where the glass plate 1 is divided in a manner described below). Then, the front end portion of the glass plate 1 is pushed down by the holding member 25 to the dividing member 21, and thereby the second main surface 1b of the glass plate 1 is brought into contact with the dividing member 21. As a result, the glass plate 1 is heated up from the second main surface 1b side along the division-planned line 2, and owing to a temperature difference between the second main surface 1b and the first main surface 1a, a compression thermal stress derived from thermal expansion is generated on the second main surface 1b, and a tensile thermal stress derived from reaction force of the thermal expansion is generated on the first main surface 1a.

Thereafter, the front end portion of the glass plate 1 is pushed down further by the holding member 25, and thereby the dividing member 21 is pressed onto the glass plate 1. As a result, similar to Embodiment 1, bending force A in the thickness direction of the glass plate 1 is applied to the second main surface 1b of the glass plate 1 along the division-planned line 2, and the glass plate 1 made of a brittle material is divided along the division-planned line 2 owing to a stress derived from the bending force and a thermal stress derived from the heating by the dividing member 21 (to be specific, owing to the following stresses that are combined together: a tensile stress derived from a bending stress on the first main surface 1a, in which the start point flaw 16 is formed, and a tensile thermal stress).

In addition, in the present embodiment, since one end of the glass plate 1 is pushed down to the dividing member 21 to divide the glass plate 1, when the glass plate 1 is divided along the division-planned line 2, the glass plate 1 immediately rises back to a height position that is the same as the height position of the holding member 24. Therefore, it is not necessary to retreat the dividing member 21 from the glass plate 1 after dividing the glass plate 1.

### Embodiment 3

FIG. 7 is a side view showing a plate member dividing apparatus according to Embodiment 3 of the present invention. A dividing apparatus 30 according to the present embodiment indicates one example of dividing the glass plate 1 along the division-planned line 2 by using the dividing member 31, which cools down the glass plate 1 by contact cooling. A specific description of the same components as those of Embodiment 1 is omitted below.

As shown in FIG. 7, a pair of holding members 34 and 35 is provided above the glass plate 1, i.e., provided at the first main surface 1a side of the glass plate 1. The pair of holding members 34 and 35 holds the first main surface 1a of the glass plate 1 on a pair of lines between which the division-planned line 2 is laid, the pair of lines being parallel to the division-planned line 2. The dividing member 31, which cools down the first main surface 1a of the glass plate 1 by contact cooling, is disposed above the glass plate 1 in a manner crossing the conveying direction F. The dividing member 31 extends along the division-planned line 2, which is perpendicular to the conveying direction F of the glass plate 1. The dividing member 31 is connected to a cooling device that is not shown (in a manner similar to the connection to the heater 13 shown in FIG. 1). The cooling device cools down the dividing member 31 to a predetermined cooling temperature by use of liquefied nitrogen, dry ice, a refrigerant of a refrigeration apparatus, or the like. The dividing member 31, by coming into contact with the first main surface 1a of the glass plate 1, cools down a portion of the first main surface 1a, the portion being contacted by the dividing member 31, to a temperature that is substantially the same as the temperature of the dividing member 31. The predetermined cooling temperature of the dividing member 31 is about +20° C. to −50° C., for example. The cooling temperature is set in accordance with the temperature of the plate member.

The dividing member 31 is driven by a first driver 32 to advance or retreat such that the dividing member 31 comes into contact with or moves away from the glass plate 1. That is, the first driver 32 drives the dividing member 31 to move upward or downward.

A pressing member 36, which is pressed onto the glass plate 1 along the division-planned line 2, is provided below the glass plate 1, i.e., provided at the second main surface 1b side of the glass plate 1. The pressing member 36 is disposed facing the dividing member 31, and extends along the division-planned line 2 similar to the dividing member 31. The pressing member 36 is configured to be driven by a second driver 37 provided under the pressing member 36 to advance or retreat. The second driver 37 drives the pressing member 36 to move upward or downward. As a result of the pressing member 36 being driven by the second driver 37 to move upward, the pressing member 36 is pressed onto the glass plate 1 against the dividing member 31 when the dividing member 31 is in contact with the glass plate 1. As one example, linear actuators or the like can be used as the first driver 32 and the second driver 37. The cross-sectional shape of the pressing member 36 is set such that a portion of the pressing member 36, the portion coming into contact with the glass plate (plate member) 1, has a contact angle less than an angle of bend of the glass plate 1 when the glass plate 1 is divided.

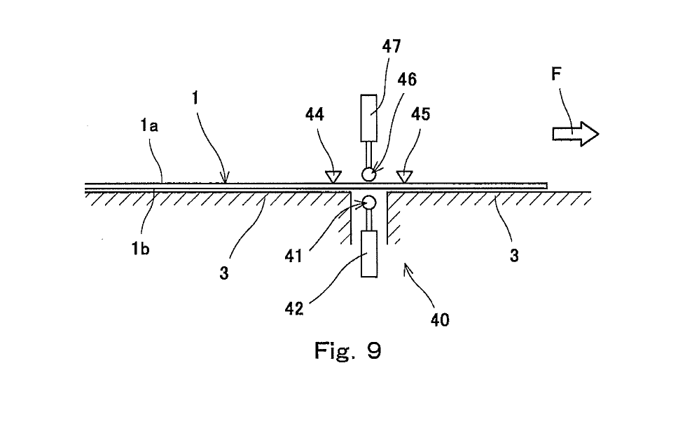

FIG. 8 is an enlarged side view illustrating functions that are exercised at the time of dividing the glass plate 1 by the dividing apparatus 30 shown in FIG. 7. In FIG. 8, changes that occur when the dividing member 31 is brought into contact with the glass plate 1 and the pressing member 36 is pressed onto the glass plate 1 are shown in an exaggerated manner.

When the dividing member 31 is brought into contact with the first main surface 1a of the glass plate 1 along the division-planned line 2 by using the first driver 32 in the above-described manner, the glass plate 1 is cooled down from the first main surface 1a side along the division-planned line 2 (heat is indicated by arcs). Owing to a temperature difference between the first main surface 1a and the second main surface 1b, a tensile thermal stress derived from thermal contraction is generated on the first main surface 1a, and a compression thermal stress derived from reaction force of the thermal contraction is generated on the second main surface 1b. Thereafter, by using the second driver 37, the pressing member 36 is pressed onto the glass plate 1 along the division-planned line 2 from the opposite side to the dividing member 31 as seen from the glass plate 1. In this manner, bending force A in the thickness direction of the glass plate 1 is applied to the second main surface 1b of the glass plate 1 along the division-planned line 2. The moment that acts on the glass plate 1 is greatest at a position where the pressing member 36 contacts the glass plate 1. As a result, a compression stress acts on the second main surface 1b of the glass plate 1, and a tensile stress acts on the first main surface 1a of the glass plate 1.

Accordingly, along the division-planned line 2 of the glass plate 1, the tensile stress derived from the bending force A is combined with the tensile thermal stress derived from the thermal contraction, and these stresses act on the first main surface 1a. Further, the compression stress derived from the bending force A is combined with the compression thermal stress derived from the reaction force of the thermal contraction of the first main surface 1a, and these stresses act on the second main surface 1b. As a result, a crack progresses along the division-planned line 2 from the start point flaw 16 formed in the first main surface 1a. Consequently, the glass plate 1 made of a brittle material is divided along the division-planned line 2 owing to brittle fracture. That is, the thermal stress that occurs from the temperature difference between the front and the back of the glass plate 1, the temperature difference being caused by the cooling by the dividing member 31, and the stress derived from the bending force A applied to the glass plate 1 by the pressing member 36 are combined together to become a fracture stress, and as a result, the glass plate 1 is divided. In addition, owing to these stresses, the glass plate 1 can be divided apart instantly (e.g., in about 1 to 3 seconds).

As described above, in the case of using the dividing member 31, which cools down the first main surface 1a of the glass plate 1 by contact cooling, and the pressing member 36, the axes of the dividing member 31 and the pressing member 36 are brought into contact with the glass plate 1 along the division-planned line 2, and at the same time, a bending moment is caused to act on the glass plate 1 along the division-planned line 2. This makes it possible to instantly divide the glass plate 1 apart along the axis of the dividing member 31.

Therefore, according to the dividing apparatus 30, the generation of dividing dust can be suppressed at the time of dividing the glass plate (plate member) 1, and the dividing apparatus 30 can be configured as a compact dividing apparatus with reduced apparatus components.

In the present embodiment using the dividing member 31, which cools down the first main surface 1a of the glass plate 1 by contact cooling in the above-described manner, since the glass plate 1 has a temperature of about 300° C. to 100° C. immediately after the glass plate 1 is produced, the dividing member 31 in a cooled-down state may be brought into contact with the glass plate 1 in such a high-temperature state. In this case, the glass plate 1 can be readily divided owing to the difference between the temperature of the glass plate 1 and the temperature of the dividing member 31. In this case, the glass plate 1 can be divided into pieces each having a predetermined size at the time of producing the glass plate 1. Therefore, the efficiency of the production process of the glass plate 1 can be improved. This makes it possible to improve the efficiency of the work of dividing the glass plate 1 into pieces each having a predetermined size.

### Embodiment 4

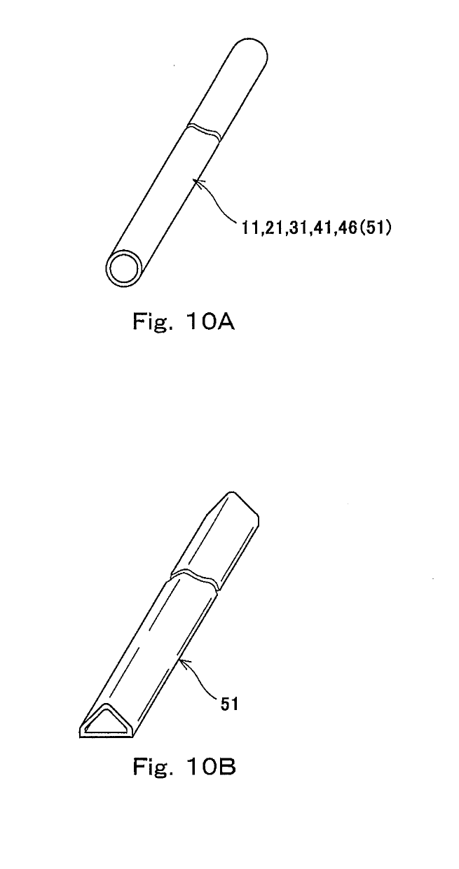

FIG. 9 is a perspective view showing a plate member dividing apparatus according to Embodiment 4 of the present invention. A dividing apparatus 40 according to the present embodiment performs a combination of the contact heating of Embodiment 1 and the contact cooling of Embodiment 3. A specific description of the same components as those of Embodiments 1 and 2 is omitted below.

As shown in FIG. 9, the dividing apparatus 40 according to the present embodiment cools down the glass plate 1 along the division-planned line 2 from the first main surface 1a side where the start point flaw 16 is formed, and heats up the glass plate 1 from the second main surface 1b side. A first dividing member 41, which heats up the second main surface 1b of the glass plate 1 by contact heating, is disposed below the glass plate 1, i.e., disposed at the second main surface 1b side of the glass plate 1, and extends along the division-planned line 2 perpendicular to the conveying direction F of the glass plate 1. A second dividing member 46 (corresponding to the secondary dividing member of the present invention), which cools down the first main surface 1a of the glass plate 1 by contact cooling, is disposed above the glass plate 1, i.e., disposed at the first main surface 1a side of the glass plate 1, and extends along the division-planned line 2 perpendicular to the conveying direction F. The first dividing member 41 and the second dividing member 46 are driven by a first driver 42 and a second driver 47 so that these dividing members can advance toward and retreat from the glass plate 1. The first driver 42 is configured in the same manner as the driver 12 (see FIG. 2) of Embodiment 1, and the second driver 37 is configured in the same manner as the first driver 32 (see FIG. 7) of Embodiment 3. Above the glass plate 1, a pair of holding members 44 and 45 is provided, which holds the first main surface 1a of the glass plate 1 on a pair of lines between which the division-planned line 2 is laid, the pair of lines being parallel to the division-planned line 2.

According to the dividing apparatus 40 of Embodiment 4 as described above, the second dividing member 46, which cools down the first main surface 1a of the glass plate 1 by contact cooling, is brought into contact with the first main surface 1a of the glass plate 1 along the division-planned line 2. At the same time, the first dividing member 41, which heats up the second main surface 1b of the glass plate 1 by contact heating, is brought into contact with the second main surface 1b of the glass plate 1 along the division-planned line 2. Thereafter, the first dividing member 41 is pressed onto the glass plate 1 against the second dividing member 46. Consequently, a compression thermal stress derived from thermal expansion resulting from the heating of the second main surface 1b and its vicinity by the first dividing member 41 and a compression stress derived from bending force act on the second main surface 1b of the glass plate 1 along the division-planned line 2. Also, a tensile thermal stress derived from thermal contraction resulting from the cooling of the first main surface 1a and its vicinity by the second dividing member 46 and a tensile stress derived from the bending force act on the first main surface 1a along the division-planned line 2. These stresses acting on the glass plate 1 are combined together to become a fracture stress, and as a result, the glass plate 1 is divided apart along the division-planned line 2 instantly.

Moreover, in addition to a tensile thermal stress derived from reaction force of the thermal expansion resulting from the heating of the second main surface 1b and its vicinity by the first dividing member 41 and the tensile stress derived from the bending force, the tensile thermal stress derived from the thermal contraction resulting from the cooling of the first main surface 1a and its vicinity by the second dividing member 46 acts on the first main surface 1a. This makes it possible to generate a greater stress along the division-planned line 2 for dividing the glass plate 1 along the division-planned line 2. In the case of using both contact heating and contact cooling as in the present embodiment, a greater temperature gradient can be obtained, and as a result, a greater thermal stress occurs, which makes it possible to divide the glass plate 1 along the division-planned line 2 with less bending force. In addition, a time required for dividing the glass plate 1 is reduced.

### Other Embodiments

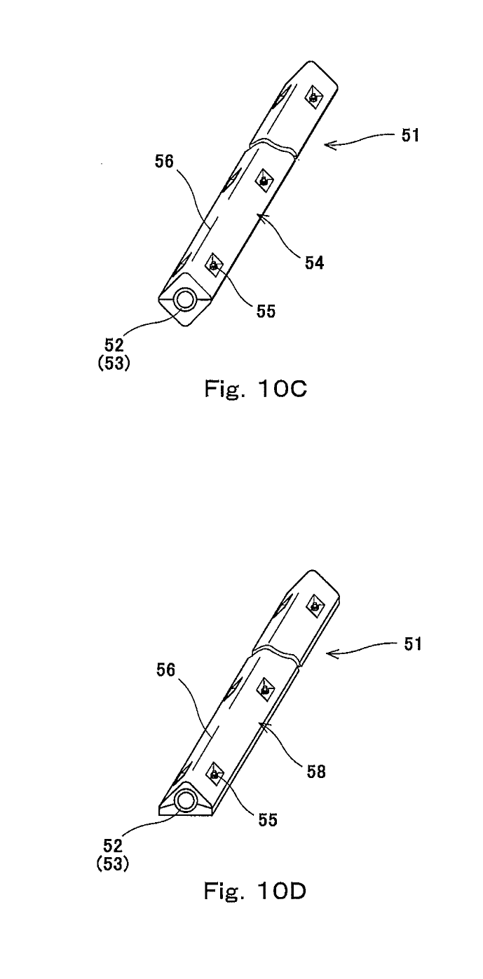

As described in the above embodiments and shown in FIG. 9A, a member having a round cross section can be used as each of the dividing members 11, 21, 31, 41, and 46. (Hereinafter, each of the dividing members 11, 21, 31, 41, and 46 is referred to as a dividing member 51). However, as an alternative, the dividing member 51 may have any one of the configurations shown in FIGS. 10B to 10D.

FIG. 10B shows an example where the cross section of the dividing member 51 is substantially triangular. Alternatively, as shown in FIG. 10C, the dividing member 51 may be formed by inserting a sheathed heater 52, a refrigerant pipe 53, or the like with a round cross section into a metal container 54 (e.g., a stainless steel container) with a rectangular cross section. In this case, for example, the metal container 54 may be equally bisected into two portions that are to be connected together by bolts 55, and thereby the sheathed heater 52, the refrigerant pipe 53, or the like can be disposed inside the metal container 54. By inserting the sheathed heater 52, the refrigerant pipe 53, or the like in the metal container 54, a contacting portion 56 (the upper end portion shown in FIG. 10C) of the metal container 54, the contacting portion 56 coming into contact with the glass plate 1, can be formed precisely by mechanical machining, and also, the angle of contact with the glass plate 1 at the time of dividing the glass plate 1 can be set to an intended angle.

Alternatively, as shown in FIG. 10D, the dividing member 51 may be formed by inserting the sheathed heater 52, the refrigerant pipe 53, or the like with a substantially triangular cross section into a metal container 58. Also in this case, the contacting portion 56 (the upper end portion shown in FIG. 10D) of the metal container 58, the contacting portion 56 coming into contact with the glass plate 1, can be formed precisely by mechanical machining, and also, the angle of contact with the glass plate 1 at the time of dividing the glass plate 1 can be set to an intended angle.

As described above, the sheathed heater 52, the refrigerant pipe 53, or a container in which the sheathed heater 52 or the refrigerant pipe 53 is inserted can be used as the dividing member 51. However, the configuration of the dividing member is not limited to these examples. The dividing member may be configured differently.

### Summary

As described above, according to the plate member dividing apparatuses 10, 20, 30, and 40, the glass plate (plate member) 1 is heated up by contact heating and/or cooled down by contact cooling along the division-planned line 2. At the time, a thermal stress is generated, and the thermal stress and a stress derived from the bending force applied in the thickness direction of the glass plate 1 are combined together. In this manner, the glass plate 1 can be divided while suppressing the generation of dividing dust. Since the generation of dividing dust is suppressed, the cleaning device for cleaning up the dividing dust is unnecessary, and in addition, the scribing device is unnecessary. Therefore, the configuration for dividing the glass plate (plate member) 1 can be made compact, and thereby the size and cost of the apparatus can be reduced.

Since the glass plate (plate member) 1 is divided along the division-planned line 2 by utilizing the thermal stress and the stress derived from the bending force, the glass plate 1 is divided in a clean manner. Consequently, there will be no fine chips on the divided portions of the glass plate 1. Accordingly, the edge strength of the glass plate 1 after being divided is high. In addition, since chamfering is unnecessary, the size and cost of the apparatus can be reduced also in this regard.

Thus, the present invention makes it possible to provide a high-quality glass plate (plate member) 1 not only in the FPD industry but in various fields such as the fields of building materials and automobiles.

The above embodiments describe the glass plate 1 as one example of a plate member made of a brittle material. However, the plate member is not limited to the one described in the above embodiments, but may be any plate member, so long as the plate member is made of a brittle material and can be divided by utilizing a thermal stress and a stress derived from bending force.

The above embodiments describe examples where the plate member made of a brittle material (the glass plate 1) is divided along the division-planned line 2 perpendicular to the conveying direction F. However, the division-planned line 2, along which the plate member is divided, may cross the conveying direction F at any predetermined angle different from a right angle, so long as the division-planned line 2 is a straight line. Thus, the division-planned line 2 is not limited to a line perpendicular to the conveying direction F.

It is not essential for the dividing apparatus to include the flaw forming device 17. Before the glass plate 1 is fed into the dividing apparatus, the start point flaw 16 may be formed in the first main surface 1a of the glass plate 1 by a device provided separately from the dividing apparatus.

The above embodiments describe non-limiting examples. The embodiments can be combined and various modifications can be made to the embodiments without departing from the spirit of the present invention. Thus, the present invention is not limited to the above-described embodiments.

### INDUSTRIAL APPLICABILITY

The plate member dividing method according to the present invention is useful for dividing a plate member whose quality needs to be kept high, such as a glass plate of a liquid crystal display.

### REFERENCE SIGNS LIST

1 glass plate (plate member made of a brittle material)
1a first main surface
1b second main surface
2 division-planned line
3 conveying apparatus
10 dividing apparatus
11 dividing member
12 driver
13 heater
14 holding member
15 holding member
16 start point flaw (scribed mark)
17 flaw forming device
20 dividing apparatus
21 dividing member
22 driver
24 holding member
25 holding member
30 dividing apparatus
31 dividing member
32 first driver
34 holding member
35 holding member
36 pressing member
37 second driver
40 dividing apparatus
41 first dividing member
42 first driver
44 holding member
45 holding member
46 second dividing member
47 second driver
51 dividing member
52 sheathed heater
53 refrigerant pipe
54 metal container
56 contacting portion
58 metal container
60 tensile machine

1. A method of dividing a plate member made of a brittle material along a division-planned line, the method comprising:
forming a minute start point flaw in a first main surface of the plate member on the division-planned line;
holding the first main surface of the plate member on a pair of lines between which the division-planned line is laid, the pair of lines being parallel to the division-planned line; and
dividing the plate member along the division-planned line by bringing a dividing member that extends along the division-planned line and that heats up or cools down the plate member by contact heating or contact cooling into contact with the plate member to generate a tensile thermal stress on the first main surface of the plate member and by applying bending force in a thickness direction of the plate member to a second main surface of the plate member along the division-planned line, the second main surface facing in a direction opposite to a facing direction of the first main surface, such that a tensile stress derived from the bending force and the tensile thermal stress are combined together.

2. The method of dividing a plate member made of a brittle material according to claim 1, wherein
the dividing member is disposed at the second main surface side of the plate member and heats up the second main surface of the plate member by contact heating,
the dividing member is brought into contact with the second main surface of the plate member to generate the tensile thermal stress on the first main surface of the plate member, and
the dividing member is pressed onto the plate member to apply the bending force in the thickness direction of the plate member to the second main surface of the plate member.

3. The method of dividing a plate member made of a brittle material according to claim 2, wherein
dividing the plate member includes:
bringing the dividing member into contact with the second main surface of the plate member; and
bringing a secondary dividing member that is disposed at the first main surface side of the plate member in a manner extending along the division-planned line and that cools down the first main surface of the plate member by contact cooling into contact with the first main surface of the plate member.

4. The method of dividing a plate member made of a brittle material according to claim 1, wherein
the dividing member is disposed at the first main surface side of the plate member and cools down the first main surface of the plate member by contact cooling, and
dividing the plate member includes:
bringing the dividing member into contact with the first main surface of the plate member; and
pressing a pressing member that is disposed facing the dividing member and that extends along the division-planned line onto the plate member against the dividing member to apply the bending force in the thickness direction of the plate member to the second main surface of the plate member.

5. The method of dividing a plate member made of a brittle material according to claim 1, wherein
dividing the plate member includes pulling the plate member in a direction perpendicular to the division-planned line.

6. The method of dividing a plate member according to claim 1, wherein
the start point flaw is formed in an end portion of the plate member.

7. An apparatus for dividing a plate member made of a brittle material along a division-planned line, the plate member including a first main surface, in which a minute start point flaw is formed on the division-planned line,
the apparatus comprising:
a pair of holding members that holds the first main surface of the plate member on a pair of lines between which the division-planned line is laid, the pair of lines being parallel to the division-planned line;
a dividing member that is disposed at a second main surface side of the plate member in a manner extending along the division-planned line and that heats up a second main surface of the plate member by contact heating, the second main surface facing in a direction opposite to a facing direction of the first main surface; and
a driver that drives the dividing member to bring the dividing member into contact with the second main surface of the plate member to generate a tensile thermal stress on the first main surface of the plate member and press the dividing member onto the plate member to apply bending force in a thickness direction of the plate member to the second main surface of the plate member along the division-planned line, such that a tensile stress derived from the bending force and the tensile thermal stress are combined together and the plate member is divided along the division-planned line.

8. The apparatus for dividing a plate member made of a brittle material according to claim 7, further comprising a secondary dividing member that is disposed at the first main surface side of the plate member in a manner extending along the division-planned line and that is brought into contact with the first main surface of the plate member to cool down the first main surface of the plate member by contact cooling.

9. An apparatus for dividing a plate member made of a brittle material along a division-planned line, the plate member including a first main surface, in which a minute start point flaw is formed on the division-planned line;
the apparatus comprising:
a pair of holding members that holds the first main surface of the plate member on a pair of lines between which the division-planned line is laid, the pair of lines being parallel to the division-planned line;
a dividing member that is disposed at the first main surface side of the plate member in a manner extending along the division-planned line and that cools down the first main surface of the plate member by contact cooling;
a first driver that drives the dividing member to bring the dividing member into contact with the first main surface of the plate member to generate a tensile thermal stress on the first main surface of the plate member;
a pressing member disposed facing the dividing member and extending along the division-planned line; and
a second driver that drives the pressing member to press the pressing member onto the plate member against the dividing member to apply bending force in a thickness direction of the plate member to a second main surface of the plate member along the division-planned line, the second main surface facing in a direction opposite to a facing direction of the first main surface, such that a tensile stress derived from the bending force and the tensile thermal stress are combined together and the plate member is divided along the division-planned line.

10. The apparatus for dividing a plate member made of a brittle material according to claim 7, further comprising a tensile machine that pulls the plate member in a direction perpendicular to the division-planned line.

11. The apparatus for dividing a plate member according claim 7, further comprising a flaw forming device that forms the start point flaw in the first main surface of the plate member on the division-planned line.

12. The apparatus for dividing a plate member made of a brittle material according to claim 7, wherein
a portion of the dividing member that heats up the second main surface of the plate member by contact heating, the portion coming into contact with the plate member, is formed to have a shape that has a contact angle less than an angle of bend of the plate member when the plate member is divided along the division-planned line.

13. The apparatus for dividing a plate member made of a brittle material according to claim 9, wherein
a portion of the pressing member, the portion coming into contact with the plate member, is formed to have a shape that has a contact angle less than an angle of bend of the plate member when the plate member is divided along the division-planned line.

14. The apparatus for dividing a plate member made of a brittle material according to claim 9, further comprising a tensile machine that pulls the plate member in a direction perpendicular to the division-planned line.

15. The apparatus for dividing a plate member according to claim 9, further comprising a flaw forming device that forms the start point flaw in the first main surface of the plate member on the division-planned line.
